(19) United States
(12) Patent Application Publication
(10) Pub. No.: US 2017/0092120 A1
(43) Pub. Date: Mar. 30, 2017

(54) COMMON INFORMATION OUTPUT METHOD, COMMON INFORMATION OUTPUT DEVICE AND NON-TRANSITORY COMPUTER-READABLE STORAGE MEDIUM

(71) Applicant: FUJITSU LIMITED, Kawasaki-shi (JP)

(72) Inventors: Junichi Shigezumi, Kawasaki (JP); Tatsuya Asai, Kawasaki (JP); Hiroaki Morikawa, Kawasaki (JP); Hiroya INAKOSHI, Tama (JP)

(73) Assignee: FUJITSU LIMITED, Kawasaki-shi (JP)

(21) Appl. No.: 15/271,598

(22) Filed: Sep. 21, 2016

(30) Foreign Application Priority Data
Sep. 24, 2015 (JP) 2015-186769

(51) Int. Cl. G08G 1/01; G06F 17/30

(52) U.S. Cl. CPC G08G 1/0141; G08G 1/0129; G08G 1/012; G06F 17/30241

(57) ABSTRACT

A common information output method including acquiring first trajectory information and second trajectory information, the first trajectory information indicating a first node sequence corresponding to nodes at which a first object has arrived in order, the second trajectory information indicating a second node sequence corresponding to nodes at which a second object has arrived in order, specifying a number of common node based on the first trajectory information and the second trajectory information when at least a part of the first node sequence and at least a part of the second node sequence are overlapped, the specifying being executed for each of a plurality of patterns of overlap of the first node sequence and the second node sequence, and outputting information in accordance with the specified number of common node.

### CROSS-REFERENCE TO RELATED APPLICATION

This application is based upon and claims the benefit of priority of the prior Japanese Patent Application No. 2015-186769, filed on Sep. 24, 2015, the entire contents of which are incorporated herein by reference.

### FIELD

The embodiments discussed herein are related to a common information output method, a common information output device and a non-transitory computer-readable storage medium.

### BACKGROUND

There are techniques of performing analysis regarding routes of mobile bodies as spatial information analysis. For example, there are techniques of performing OD search, where each of trajectories indicated by a plurality of pieces of trajectory data, which is actual observation data, is searched for a route with a designated point that serves as an “origin (O)” or a “destination (D)”. Further, there are techniques of analyzing a frequently-occurring OD indicating an O-to-D combination that appears for not less than a predetermined number of times, such as ten, which is Shinjuku Station to Shibuya Station or Shinagawa Station to Ikebukuro Station for example, in a plurality of trajectories. In addition, there are techniques of searching trajectories for a partial route, such as a route that passes through Shinagawa Station and then through Ikebukuro Station on the outer track of Yamanote Line. Moreover, there are techniques of analyzing a frequently-occurring partial route indicating a partial route that appears for not less than a predetermined number of times, such as ten, in trajectories.

In performing such route analyses described above, a common portion or similarity between a plurality of trajectories is determined so as to recognize that mobile bodies pass an identical route. For example, techniques by which the trajectory indicated by the movement history of each of two users is converted into a semantic trajectory to compute a longest common subsequence (LCS) between the two semantic trajectories are proposed. According to the techniques, similarity between the users is calculated using the computed LCS.

Also, an algorithm that uses dynamic programming is known as techniques of computing an LCS.

J. J. Ying, E. H. -C. Lu, W. -C. Lee, T. -C. Weng, and V. S. Tseng, “Mining user similarity from semantic trajectories”, Proc. LBSN '10, pp. 19-26, 2010, and D. S. Hirschberg, “A linear space algorithm for computing maximal common subsequences”, Comm. of ACM, 18(6), pp. 341-343, 1975 are examples of related art.

### SUMMARY

According to an aspect of the invention, a common information output method executed by a computer, the common information output method including acquiring first trajectory information and second trajectory information, the first trajectory information indicating a first node sequence corresponding to nodes at which a first object has arrived in order, the second trajectory information indicating a second node sequence corresponding to nodes at which a second object has arrived in order, specifying a number of common node based on the first trajectory information and the second trajectory information when at least a part of the first node sequence indicated by the first trajectory information and at least a part of the second node sequence indicated by the second trajectory information are overlapped, the common node being same node appearing at same position in the overlapped part of the first node sequence and the overlapped part of the second node sequence, the specifying being executed for each of a plurality of patterns of overlap of the first node sequence and the second node sequence, and outputting information in accordance with the specified number of common node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a schematic structure of each of common information output devices according to first and second embodiments;

FIG. 2 illustrates examples of movement trajectories;

FIG. 3 illustrates an example of a movement trajectory database (DB);

FIG. 4 illustrates an example of a road network;

FIG. 5 illustrates an example of a road network DB;

FIG. 6 is a diagram for describing normalization of movement trajectory data;

FIG. 7 illustrates an example of a normalized trajectory DB;

FIG. 8 is a diagram for describing a common portion between paths in a network graph;

FIG. 9 illustrates an example of a common portion identified in node sequences of paths;

FIG. 10 is a diagram for describing a common portion between movement trajectories in a road network;

FIG. 11 illustrates an example of a common portion identified in node sequences of paths;

FIG. 12 illustrates an example of a common portion identified in node sequences of normalized trajectories;

FIG. 13 illustrates an example of an output information DB;

FIG. 14 is a block diagram illustrating a schematic structure of a computer that functions as each of common information output devices according to first to third embodiments;

FIG. 15 is a flow chart illustrating an example of a common information output process;

FIG. 16 is a flow chart illustrating an example of a common portion information calculation process according to the first embodiment;

FIG. 17 is a diagram for describing identification of a common portion according to the first embodiment;

FIG. 18 is a flow chart that illustrates an example of a common portion information calculation process according to a second embodiment;

FIG. 19 is a diagram for describing identification of a common portion according to the second embodiment;

FIG. 20 is a functional block diagram that illustrates a schematic structure of a route graph generation system according to a third embodiment;

FIG. 21 is a diagram for describing generation of a route graph;

FIG. 22 illustrates an example of a route graph DB; and

FIG. 23 is a flow chart illustrating an example of a route graph generation process.

### DESCRIPTION OF EMBODIMENTS

To identify a common portion among trajectory data accurately, however, a large amount of computation is desired and particularly when large-scale trajectory data is the target, combinations of the trajectory data burst and the amount of the computation further increases. For example, to identify a common portion among trajectory data included in approximately 10,000 pieces of trajectory data using a conventional algorithm, it is expected to take approximately one day.

An aspect of the present application is aimed at reducing the amount of computation desired so as to identify a common portion among trajectory data.

Examples of embodiments of the present application are described in detail below with reference to the drawings.

### First Embodiment

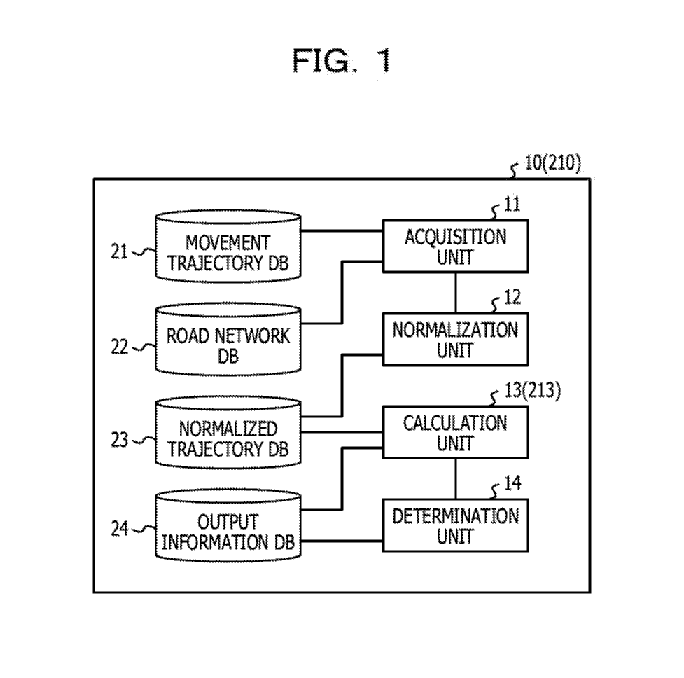

As illustrated in FIG. 1, in terms of functions, a common information output device 10 according to a first embodiment includes an acquisition unit 11, a normalization unit 12, a calculation unit 13, and a determination unit 14. A movement trajectory database (DB) 21, a road network DB 22, a normalized trajectory DB 23, and an output information DB 24 are stored in a predetermined storage area in the common information output device 10. These databases may be stored in an external storage device coupled to the common information output device 10.

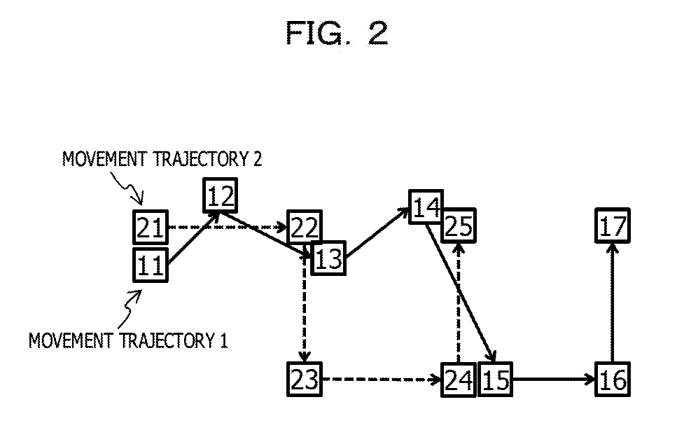

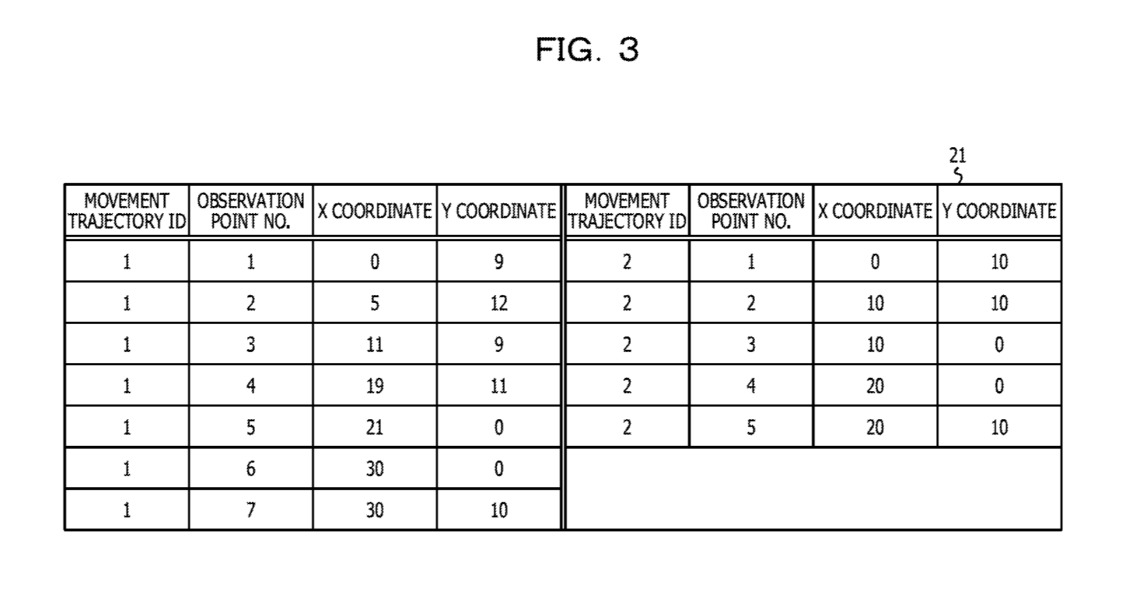

For example, movement trajectory data that indicates movement trajectories as illustrated in FIG. 2 is stored in the movement trajectory DB 21. The movement trajectories are indicated by coupling respective location information on observation points on the time series in accordance with observation data, which indicates the locations of the mobile bodies observed regularly. In the example of FIG. 2, the observation point are denoted as boxes and numbers ij in each box indicates that the identification information (movement trajectory ID) of the movement trajectory is i and the observation point is the j-th observation point. Hereinafter, the movement trajectory with the movement trajectory ID that is i may be referred to as the “movement trajectory i”. For example, as illustrated in FIG. 3, a movement trajectory ID, the number of each observation point (observation point No.) included in the movement trajectory that the movement trajectory ID indicates, and the x and y coordinates of each observation point are stored in the movement trajectory DB 21 while caused to correspond to one another. The x and y coordinates are the latitude and longitude for example.

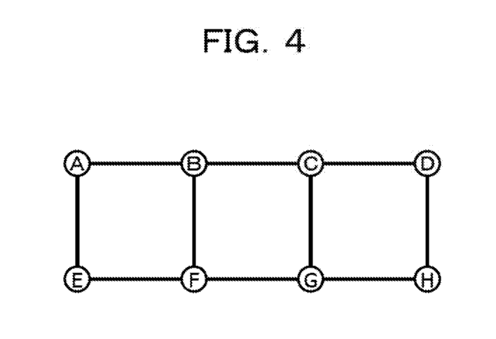

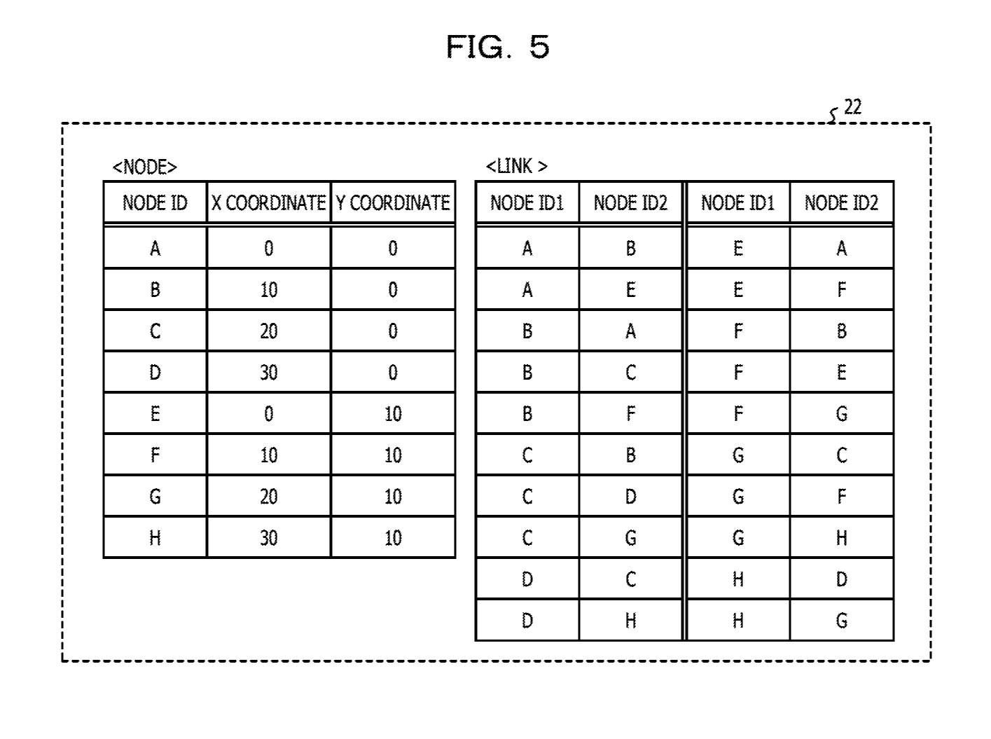

Data that indicates a road network is stored in the road network DB 22. For example, as illustrated in FIG. 4, the road network is indicated as a plurality of nodes caused to correspond to location information, which are circles in FIG. 4, and as links that couple the nodes. In the road network DB 22, for example, as illustrated in FIG. 5, the identification information on each node (each node ID) and the x and y coordinates of each node are stored while caused to correspond to one another, and link information is further stored. In the example of FIG. 5, the link information is obtained by causing a “node ID1”, which is the node ID of the node at one end of a link, and a “node ID2”, which is the node ID of the node at the other end, to correspond to each other. Hereinafter, the node with the node ID X may be denoted as the “node X”.

The acquisition unit 11 acquires each movement trajectory data from the movement trajectory DB 21. In the movement trajectory DB 21, a group of data with an identical movement trajectory ID constitutes one piece of the movement trajectory data. The acquisition unit 11 acquires data that indicates the road network of a target range from the road network DB 22. The “x coordinates” and the “y coordinates” in the road network DB 22 are used to determine whether or not it is the target range. The acquisition unit 11 transfers the acquired movement trajectory data and the data that indicates the road network to the normalization unit 12.

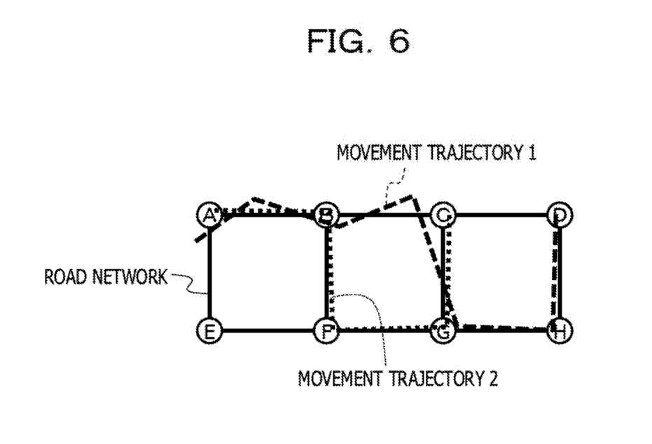

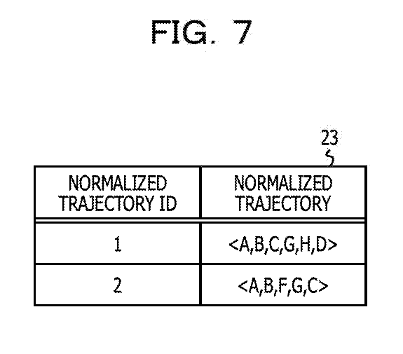

As illustrated in FIG. 6, the normalization unit 12 causes each of the movement trajectories indicated respectively by the movement trajectory data to correspond to any one of routes (paths) included in the road network by map matching or the like, and extracts nodes through which the movement trajectory passes. The normalization unit 12 acquires a node sequence in which the node IDs of the extracted nodes are enumerated as a normalized trajectory. That is, the normalization unit 12 converts the movement trajectory data into respective normalized trajectories by normalizing each piece of the movement trajectory data. For example, in the example of FIG. 6, a movement trajectory 1 passes through the route A→B→C→G→H→D. A movement trajectory 2 passes through the route A→B→F→G→C. Accordingly, the normalization unit 12 converts the movement trajectory data that indicates the movement trajectory 1 into the normalized trajectory <A, B, C, G, H, D>, and the movement trajectory data that indicates the movement trajectory 2 into the normalized trajectory <A, B, F, G, C>. The normalization unit 12 adds a normalized trajectory ID to each of the converted normalized trajectories and causes the resultant normalized trajectories to be stored in for example, the normalized trajectory DB 23 as illustrated in FIG. 7.

The calculation unit 13 acquires a pair of normalized trajectories from the normalized trajectory DB 23 as the target for identifying common portion. The pair of normalized trajectories includes two normalized trajectories. Further, the calculation unit 13 calculates information on commonness in the single pair of normalized trajectories. In the present embodiment, as the information on commonness, information on the identification of the common portion between the two normalized trajectories and the length of the common portion, which is hereinafter referred to as the “common portion length”, are calculated.

A common portion between normalized trajectories according to the present embodiment is described below.

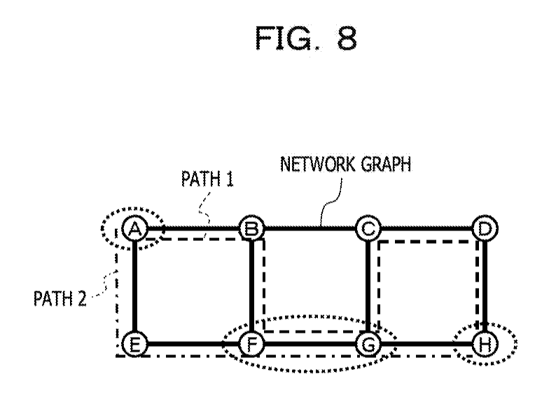

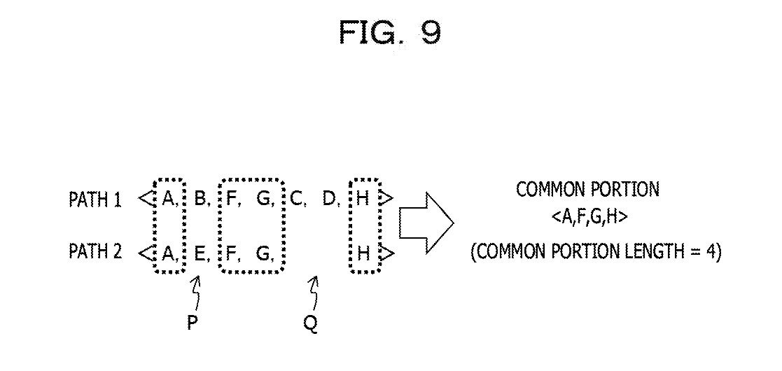

For example, a common portion between a path 1 (A→B→F→G→C→D→H) and a path 2 (A→E→F→G→H) in a network graph including nodes A to H illustrated in FIG. 8 is described. A common portion between paths represents at least one node through which both of the paths pass in common like a portion indicated with a dotted-line ellipse in FIG. 8. When a plurality of common portions are present discontinuously, what is obtained by enumerating the common portions in the order of appearance in the paths serves as a common portion to be identified. FIG. 9 illustrates an example in which the common portion of both paths, which is indicated by the dotted-line portions in FIG. 9, is identified using node sequences in which the node IDs of the nodes through which the paths pass are enumerated. In identifying the common portion, as illustrated in FIG. 9, the nodes between the common portions that are discontinuously present may be different as in the part indicated by arrow P in FIG. 9 or the number of nodes between the common portions may be different as in the part indicated by arrow Q in FIG. 9. In this case, the identified common portion between the path 1 and the path 2 is <A, F, G, H> and the common portion length indicated by the number of nodes included in the identified common portion is four.

Although FIGS. 8 and 9 illustrate an example in which the start points and the end points of both paths are identical, respectively, the start points and the end points of both paths may be nonidentical in actuality. Thus, in order to find a common portion between the paths, it is desired to search for a common portion with the largest common portion length in view of a difference in the number of nodes between the common portions, which is described above, while variously changing combinations of corresponding nodes between both paths by for example, inserting a blank character. As a result, the amount of computation desired for identifying a common portion increases.

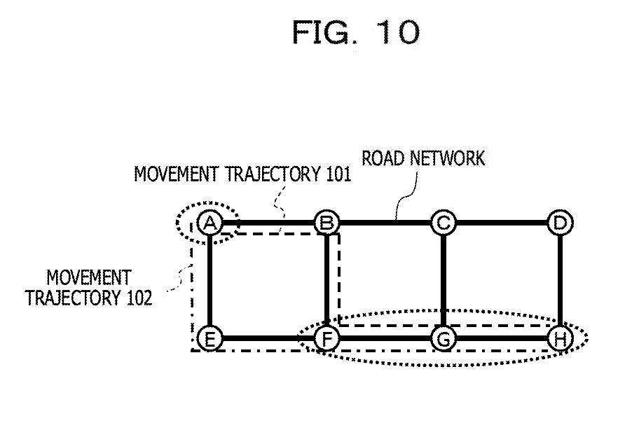

In the present embodiment, the normalized trajectories obtained by normalizing the movement trajectories of mobile bodies constitute the paths in FIG. 8. As illustrated in FIG. 8, when considering a path in a general network graph, various paths may be assumed from a node to another node. In contrast, FIG. 10 illustrates an example in which each of movement trajectories 101 and 102 from a position corresponding to node A to a position corresponding to node H is caused to correspond to a road network. Portions indicated with dotted-line ellipses in FIG. 10 are common portions between the movement trajectory 1 and the movement trajectory 2. As illustrated in the present example, it is conceivable that the mobile bodies are unlikely to select unnatural routes, which are detours for example. Thus, the numbers of nodes through which the movement trajectories pass after separating before becoming together again, that is, between common portions present discontinuously are highly likely to be the same.

Thus, in the present embodiment, reduction in the amount of computation desired for identifying a common portion is attempted by approximately calculating common portions between normalized trajectories while utilizing such characteristics of the movement trajectories.

Specifically, the calculation unit 13 arranges one normalized trajectory, which is included in a pair of normalized trajectories, on the upper side and arranges the other normalized trajectory on the lower side so that the normalized trajectories are in parallel and the node IDs of each row correspond to each other one by one. Hereinafter, in overlapping portions between the one normalized trajectory and the other normalized trajectory, node IDs at corresponding positions, that is, a node ID of the one normalized trajectory and a node ID of the other normalized trajectory, which are present at the same column, are referred to as a “node pair”. After that, the calculation unit 13 calculates the number of nodes that overlap between the one normalized trajectory and the other normalized trajectory, that is, the number of node pairs with common node IDs for each of the arrangements where the numbers of node pairs differ from each other.

More specifically, in the parallel arrangements of both normalized trajectories, an arrangement where the node ID at the left (front) end of the one normalized trajectory and the node ID at the right (rear) end of the other normalized trajectory correspond to each other is referred to as an initial arrangement. An arrangement where the node ID at the right end of the one normalized trajectory and the node ID at the left end of the other normalized trajectory correspond to each other is referred to as a final arrangement. The calculation unit 13 calculates the number of node pairs with common node IDs for each arrangement by shifting the other normalized trajectory to the right side by one column from the initial arrangement to the final arrangement. The calculation unit 13 identifies a node sequence in which the node IDs indicated respectively by the node pairs in a case where the number of node pairs with common node IDs calculated for each arrangement is the largest are enumerated as a common portion between both normalized trajectories.

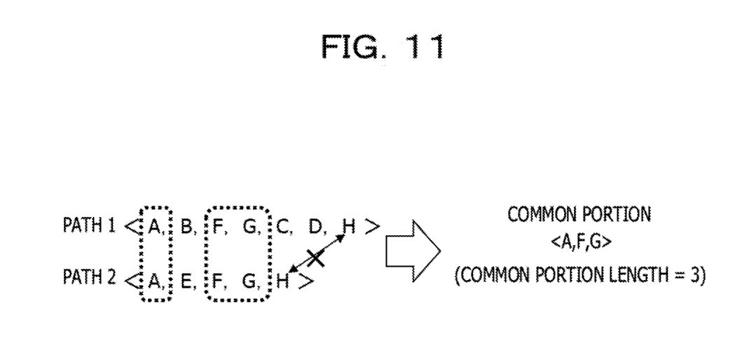

As regards the paths of the general network graph described with reference to FIGS. 8 and 9, the number of nodes between common portions present discontinuously varies. Thus, when a common portion is approximately identified simply by shifting the node sequence of each path by one column as described above, the common portion may fail to be identified with accuracy. FIG. 11 illustrates an example in which a common portion between the path 1 and the path 2 of the example in FIGS. 8 and 9 is approximately identified. As illustrated in FIG. 11, in the present example, since the numbers of nodes between node G and node H are different between the path 1 and the path 2, node H, which is a common portion originally, fails to be identified as a common portion.

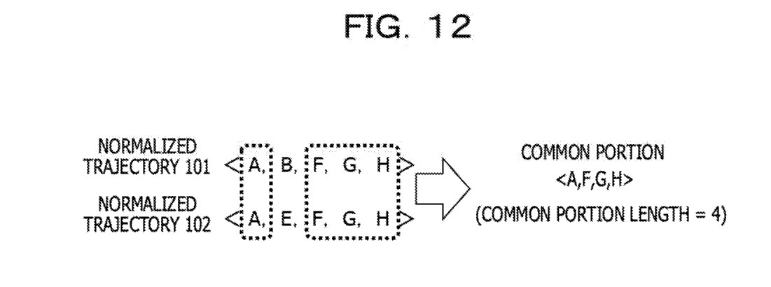

In contrast, when a common portion between normalized trajectories is identified as in the present embodiment, as described above, the numbers of nodes between common portions present discontinuously are highly likely to be the same. Thus, even when a common portion is approximately identified simply while shifting the node sequence of each normalized trajectory by one column, as illustrated in FIG. 12, the common portion may be identified with accuracy.

The calculation unit 13 calculates the number of node IDs included in the identified common portion as a common portion length. The calculation of the common portion length may be presented as expression (1) below. In expression (1), tᵢ represents the i-th node ID of the one normalized trajectory, sᵢ represents the i-th node ID of the other normalized trajectory, |t| represents the length of the one normalized trajectory (the number of node IDs), and |s| represents the length of the other normalized trajectory. Further, {i:tᵢ=sᵢ₊ₖ} represents the number of node pairs, which satisfies that tᵢ=sᵢ₊ₖ.

$${max}_{1 - \vert t \vert \leq k \leq \vert s \vert - 1} \{ i \text{:} {t}_{i} = {s}_{i + k} \} \qquad ( 1 )$$

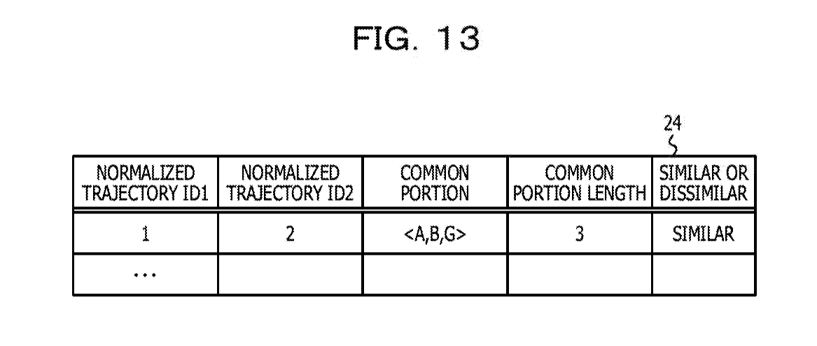

The calculation unit 13 notifies the calculated common portion length to the determination unit 14 and causes the identified common portion and the calculated common portion length to be stored in for example, the output information DB 24 as illustrated in FIG. 13. In the output information DB 24 in FIG. 13, “NORMALIZED TRAJECTORY ID1”, which is the normalized trajectory ID of the one normalized trajectory included in a pair of normalized trajectories, and “NORMALIZED TRAJECTORY ID2”, which is the normalized trajectory ID of the other normalized trajectory, are stored while caused to correspond to a common portion and a common portion length. The item “SIMILAR OR DISSIMILAR” is described below.

The determination unit 14 compares the common portion length notified from the calculation unit 13 with a predetermined threshold value and when the common portion length is equal to or larger than the threshold value, determines that both normalized trajectories included in the single pair of normalized trajectories are similar to each other. Further, when the common portion length is smaller than the threshold value, the determination unit 14 determines that both normalized trajectories are dissimilar to each other. The determination unit 14 causes the determination result to be stored in the item “SIMILAR OR DISSIMILAR” in the output information DB 24.

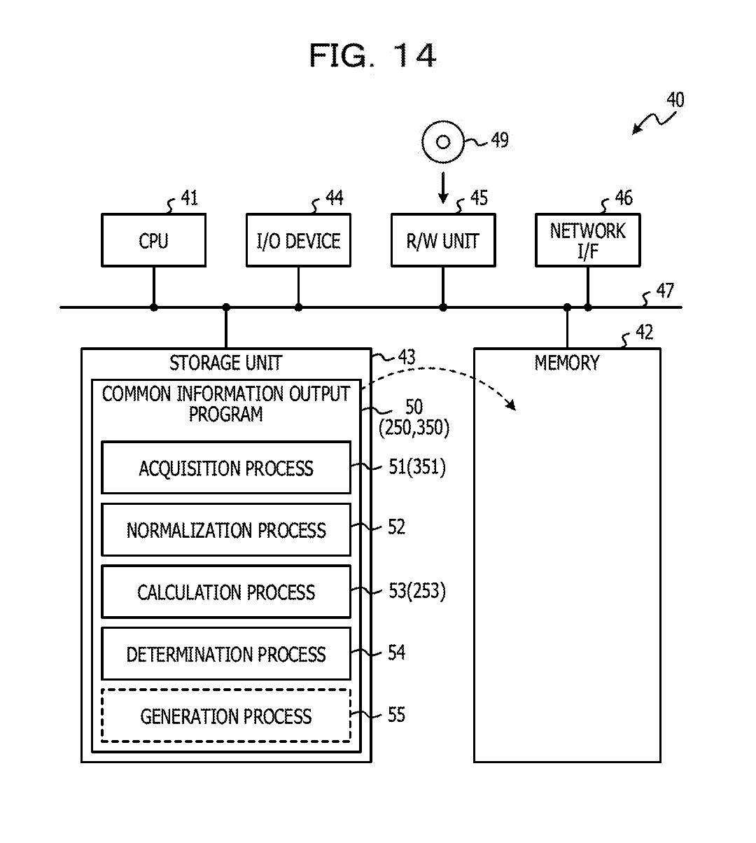

The common information output device 10 may be implemented by for example, a computer 40 illustrated in FIG. 14. The computer 40 includes a central processing unit (CPU) 41, memory 42 as a transitory storage area, and a storage unit 43, which is nonvolatile. The computer 40 further includes an input/output (I/O) device 44, a read/write (R/W) unit 45, which controls reading and writing of data performed with a recording medium 49, and a network interface (I/F) 46, which is coupled to a network, such as the Internet. The CPU 41, the memory 42, the storage unit 43, the I/O device 44, the R/W unit 45, and the network I/F 46 are coupled to one another through a bus 47.

The storage unit 43 may be implemented by a hard disk drive (HDD), a solid state drive (SSD), flash memory, or the like. The storage unit 43 as a storage medium stores a common information output program 50 for causing the computer 40 to function as the common information output device 10.

The CPU 41 reads the common information output program 50 from the storage unit 43 and expands the common information output program 50 in the memory 42 to sequentially execute processes included in the common information output program 50. The common information output program 50 includes an acquisition process 51, a normalization process 52, a calculation process 53, and a determination process 54.

The CPU 41 operates as the acquisition unit 11 illustrated in FIG. 1 by executing the acquisition process 51. The CPU 41 further operates as the normalization unit 12 illustrated in FIG. 1 by executing the normalization process 52. The CPU 41 further operates as the calculation unit 13 illustrated in FIG. 1 by executing the calculation process 53. The CPU 41 further operates as the determination unit 14 illustrated in FIG. 1 by executing the determination process 54. Accordingly, the computer 40 that executes the common information output program 50 functions as the common information output device 10.

The functions implemented by the common information output program 50 may also be implemented by for example, a semiconductor integrated circuit, and more specifically, by an application specific integrated circuit (ASIC) or the like.

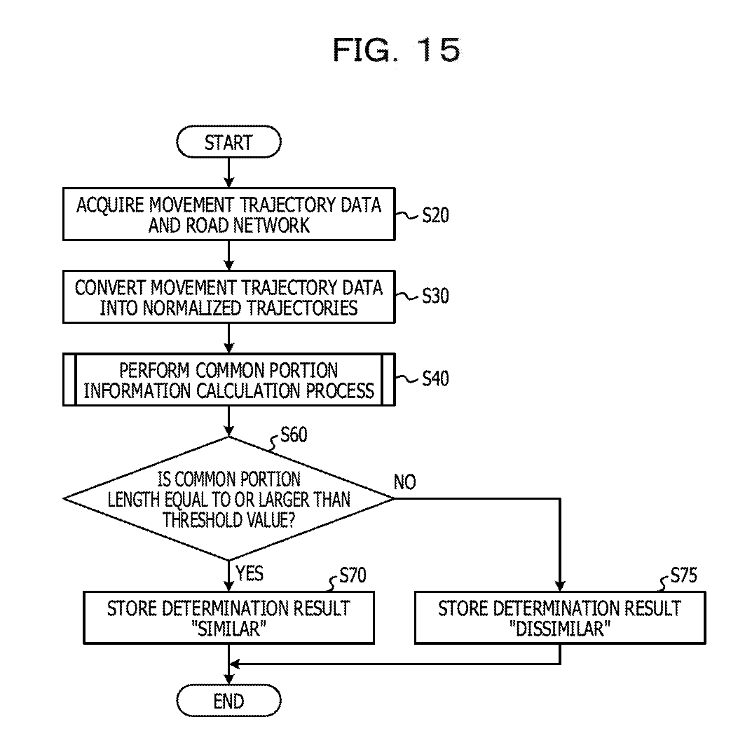

Advantages of the common information output device 10 according to the first embodiment are described below. In a state where the movement trajectory DB 21 in which a plurality of pieces of movement trajectory data are stored and the road network DB 22 that indicates a road network are prepared, the common information output process illustrated in FIG. 15 is executed in the common information output device 10. It is assumed here that the movement trajectory DB 21 illustrated in FIG. 3 and the road network DB 22 illustrated in FIG. 5 are prepared.

In step S20 of the common information output process illustrated in FIG. 15, the acquisition unit 11 acquires each movement trajectory data from the movement trajectory DB 21 and acquires data that indicates a road network of a target range from the road network DB 22 to transfer the acquired data to the normalization unit 12.

After that, in step S30, the normalization unit 12 normalizes the movement trajectories indicated by the movement trajectory data by causing the movement trajectories to correspond to the road network and converts the movement trajectory data into respective normalized trajectories. After that, the normalization unit 12 adds a normalized trajectory ID to each of the converted normalized trajectories and causes the resultant normalized trajectories to be stored in the normalized trajectory DB 23, which is illustrated in FIG. 7 for example.

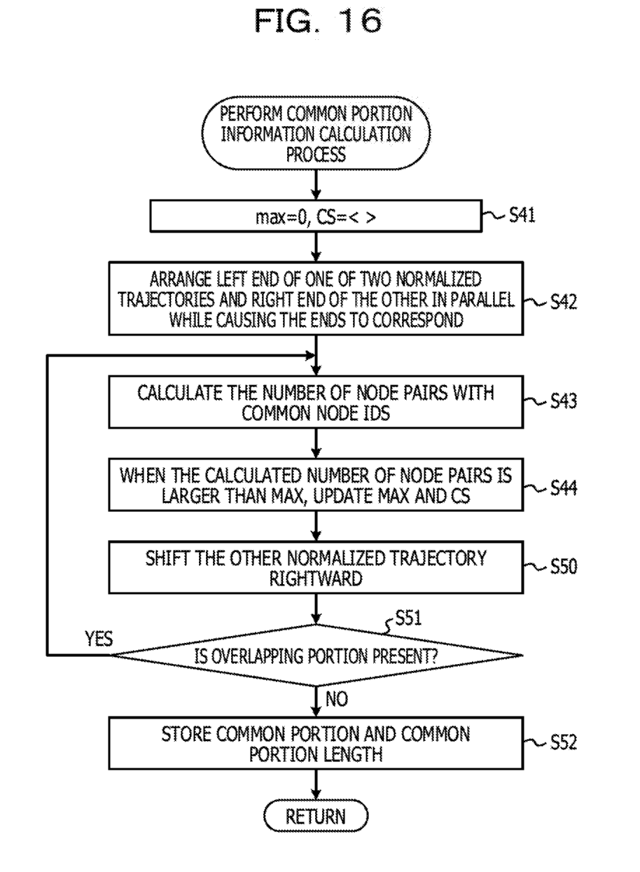

After that, in step S40, the common portion information calculation process illustrated in detail in FIG. 16 is executed.

In step S41 of the common portion information calculation process illustrated in FIG. 16, the calculation unit 13 sets a variable max used in calculating a common portion length to zero and sets a sequence CS that stores a node sequence indicating a common portion so that the sequence CS is empty.

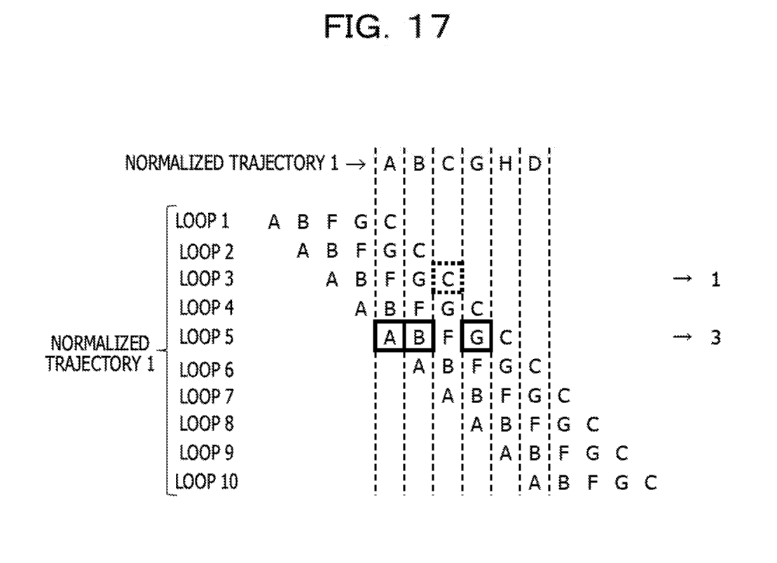

After that, in step S42, the calculation unit 13 acquires a pair of normalized trajectories from the normalized trajectory DB 23, and arranges one normalized trajectory included in the pair of normalized trajectories on the upper side and arranges the other normalized trajectory on the lower side in parallel so that the arrangement is the initial arrangement. It is assumed here that the calculation unit 13 arranges the normalized trajectory 1, which is longer, that is, larger in the number of node IDs in the two normalized trajectories, on the upper side and arranges the normalized trajectory 2, which is shorter, that is, smaller in the number of node IDs, on the lower side. Further, as illustrated in the uppermost row and the row of loop 1 in FIG. 17, the calculation unit 13 arranges the normalized trajectory 1 and the normalized trajectory 2 in parallel while causing node ID “A” at the left end of the normalized trajectory 1 and node ID “C” at the right end of the normalized trajectory 2 so that the node IDs are in the same column.

After that, in step S43, the calculation unit 13 calculates the number of node pairs with common node IDs between the normalized trajectory 1 and the normalized trajectory 2. Although one node pair is present as illustrated in the uppermost row and the row of loop 1 in FIG. 17, the two node IDs of the node pair are not the same and thus, the calculation unit 13 calculates the number of node pairs with common node IDs as “0”.

After that, in step S44, when the number of node pairs with common node IDs, which is calculated in step S43 described above, is larger than max, the calculation unit 13 updates the value of max with the calculated number of node pairs with common node IDs. Further, when max is updated, the calculation unit 13 updates the sequence CS with a node sequence in which node IDs indicated by each node pair with common node IDs are enumerated. Here, since the calculated number of node pairs with common node IDs=0 and max=0, max and CS are not updated.

After that, in step S50, as illustrated in the row of loop 2 in FIG. 17, the calculation unit 13 shifts the normalized trajectory 2 arranged on the lower side to the right side by one column.

After that, in step S51, the calculation unit 13 determines whether or not an overlapping portion, that is, a node pair is present between the normalized trajectories. When an overlapping portion is present, the procedure returns to step S43 and when no overlapping portion is present, the procedure proceeds to step S52. Since an overlapping portion is present in this case, the procedure returns to step S43 and operations of steps S43, S44, and S50 are repeated. Since a node pair with common nodes ID is not present between the normalized trajectory 1 and the normalized trajectory 2 in the arrangement indicated in the row of loop 2 in FIG. 17, either, max and CS are not updated. After that, in step S50, the calculation unit 13 shifts the arrangement of the normalized trajectory 2 further to the right side by one column to create the arrangement indicated in the row of loop 3 in FIG. 17, and the procedure returns to step S43 again.

In the arrangements of the normalized trajectory 1 indicated in the uppermost row and the normalized trajectory 2 indicated in the row of loop 3 in FIG. 17, one node pair with common node IDs (see a bold dotted-line box in FIG. 17) is present. Thus, in step S43, the calculation unit 13 calculates the number of node pairs with common node IDs as “1”. Since this value is larger than the current max equal to 0, the calculation unit 13 updates max to 1 in subsequent step S44. Further, the calculation unit 13 causes node ID “C” indicated by the node pair with common node IDs to be stored in the sequence CS so that CS=<C>.

After that, when the normalized trajectory 2 is arranged as indicated in the row of loop 4 in FIG. 17, a node pair with common nodes ID is not present between the normalized trajectory 1 and the normalized trajectory 2 and thus, max and CS are not updated.

After that, when the normalized trajectory 2 is arranged as indicated in the row of loop 5 in FIG. 17, three node pairs with common node IDs (see bold solid-line boxes in FIG. 17) are present. Thus, in step S43, the calculation unit 13 calculates the number of node pairs with common node IDs as “3”. Since this value is larger than current max equal to 1, in subsequent step S44, the calculation unit 13 updates max to 3. Further, the calculation unit 13 updates the sequence CS with a node sequence in which node IDs “A”, “B”, and “G” indicated by each node pair with common node IDs are enumerated so that CS=<A, B, G>.

After that, when the normalized trajectory 2 is arranged as indicated in each of the rows of loops 6 to 10 in FIG. 17, a node pair with common nodes ID is not present between the normalized trajectory 1 and the normalized trajectory 2 and thus, max and CS are not updated. In step S50, when the normalized trajectory 2 is shifted to the right side by one column from the arrangement indicated in the row of loop 10 in FIG. 17, no overlapping portion is present between the normalized trajectory 1 and the normalized trajectory 2 and thus, the determination result in subsequent step S51 is negative and the procedure proceeds to step S52.

In step S52, while the value currently stored as max is the common portion length and the node sequence stored in the sequence CS is the common portion, the calculation unit 13 causes the common portion length and the common portion to be stored in the output information DB 24 so that the common portion length and the common portion correspond to the normalized trajectory IDs of the normalized trajectories included in a pair of normalized trajectories. Further, the calculation unit 13 notifies the calculated common portion length to the determination unit 14. After that, the common portion information calculation process ends and the procedure returns to the common information output process illustrated in FIG. 15.

After that, in step S60 of the common information output process illustrated in FIG. 15, the determination unit 14 determines whether or not the common portion length notified from the calculation unit 13 is equal to or larger than a predetermined threshold value, which is 3 for example. When the common portion length is equal to or larger than the threshold value, the procedure proceeds to step S70 and the determination unit 14 causes the determination result that both normalized trajectories included in the single pair of normalized trajectories are similar to each other to be stored in the output information DB 24 as the item “SIMILAR OR DISSIMILAR”. In contrast, when the common portion length is smaller than the threshold value, the procedure proceeds to step S75 and the determination unit 14 causes the determination result that both normalized trajectories included in the single pair of normalized trajectories are dissimilar to each other to be stored in the item “SIMILAR OR DISSIMILAR” in the output information DB 24. After that, the common information output process ends.

As described above, in the common information output device according to the first embodiment, characteristics that the numbers of nodes between common portions between movement trajectories are highly likely to be the same are utilized to approximately identify a common portion between normalized movement trajectories. Specifically, the maximum value of the numbers of node pairs with common node IDs is calculated as a common portion length by arranging two normalized movement trajectories in parallel and performing calculation for each of the arrangements in which the numbers of overlapping nodes are different from one another. Accordingly, compared with a case where search for a common portion is performed in view of a difference in the number of nodes between common portions present discontinuously while variously changing combinations of corresponding nodes between both movement trajectories, the amount of computation desired for identifying the common portion between the movement trajectories may be reduced.

Thus, when the amount of computation desired for identifying a common portion between movement trajectories may be reduced, time taken to analyze the movement trajectories may be shortened as well and analysis whose target is large-scale data is also enabled.

In addition, from the initial arrangement in which the left end of one movement trajectory and the right end of the other movement trajectory are caused to correspond to each other, the number of node pairs with common node IDs is calculated by shifting the other movement trajectory by one column. Accordingly, arrangements with the numbers of overlapping nodes, which are different from one another, may be overall handled by a simple procedure.

Although the first embodiment describes a case where an arrangement in which the left end of one movement trajectory and the right end of the other movement trajectory are caused to correspond to each other serves as the initial arrangement and the arrangements are changed while the other movement trajectory is shifted to the right side relative to the one movement trajectory, the present disclosure is not limited thereto. An arrangement in which the right end of the one movement trajectory and the left end of the other movement trajectory are caused to correspond to each other may serve as the initial arrangement, the arrangements may be changed while the other movement trajectory is shifted to the left side relative to the one movement trajectory.

### Second Embodiment

A second embodiment is described next. In a common information output device 210 according to the second embodiment, the same references are given to parts similar to those of the common information output device 10 according to the first embodiment and detailed descriptions thereof are omitted.

As illustrated in FIG. 1, in terms of functions, the common information output device 210 according to the second embodiment includes an acquisition unit 11, a normalization unit 12, a calculation unit 213, and a determination unit 14. A movement trajectory DB 21, a road network DB 22, a normalized trajectory DB 23, and an output information DB 24 are stored in a predetermined storage area in the common information output device 210.

Similar to the calculation unit 13 according to the first embodiment, the calculation unit 213 calculates information on commonness between a pair of normalized trajectories. Hereinafter, what is different from the calculation unit 13 according to the first embodiment is described. In calculating the number of node pairs with common node IDs for each arrangement, the calculation unit 213 according to the second embodiment performs the calculation sequentially from the arrangement large in the number of overlapping nodes.

Specifically, in parallel arrangements of both normalized trajectories, an arrangement in which the node ID at the left (front) end of one of the normalized trajectories and the node ID at the left (front) end of the other normalized trajectory correspond to each other is referred to as an initial arrangement. It is assumed, for example, that in the current arrangements, the other normalized trajectory is out on the left side of the one normalized trajectory. In this case, the calculation unit 213 shifts the arrangement of the other normalized trajectory so that at least one node of the same number as the number of the outside nodes is out on the right side of the one normalized trajectory to create an arrangement in which the number of node pairs with common node IDs is calculated subsequently. For another example, it is assumed that in the current arrangements, the other normalized trajectory is out on the right side of the one normalized trajectory. In this case, the calculation unit 213 shifts the arrangement of the other normalized trajectory so that nodes of the number larger by one than the number of the outside nodes are out on the left side of the one normalized trajectory to create an arrangement in which the number of node pairs with common node IDs is calculated subsequently.

Accordingly, arrangements with the numbers of overlapping nodes, which are different from one another, may be overall handled sequentially from an arrangement large in the number of nodes. After that, when the number of overlapping nodes becomes equal to or smaller than the maximum value of the number of node pairs with common node IDs, which is already calculated, the calculation unit 213 ends the calculation of the number of node pairs with common node IDs.

The common information output device 210 may be implemented by for example, the computer 40 illustrated in FIG. 14. A common information output program 250 for causing the computer 40 to function as the common information output device 210 is stored in the storage unit 43 of the computer 40.

The CPU 41 reads the common information output program 250 from the storage unit 43 and expands the common information output program 250 in the memory 42 to sequentially execute processes included in the common information output program 250. The common information output program 250 includes an acquisition process 51, a normalization process 52, a calculation process 253, and a determination process 54.

The CPU 41 operates as the calculation unit 213 illustrated in FIG. 1 by executing the calculation process 253. The other processes are similar to those of the common information output program 50 according to the first embodiment. Accordingly, the computer 40 that executes the common information output program 250 functions as the common information output device 210.

The functions implemented by the common information output program 250 may also be implemented by for example, a semiconductor integrated circuit, and more specifically, by an ASIC or the like.

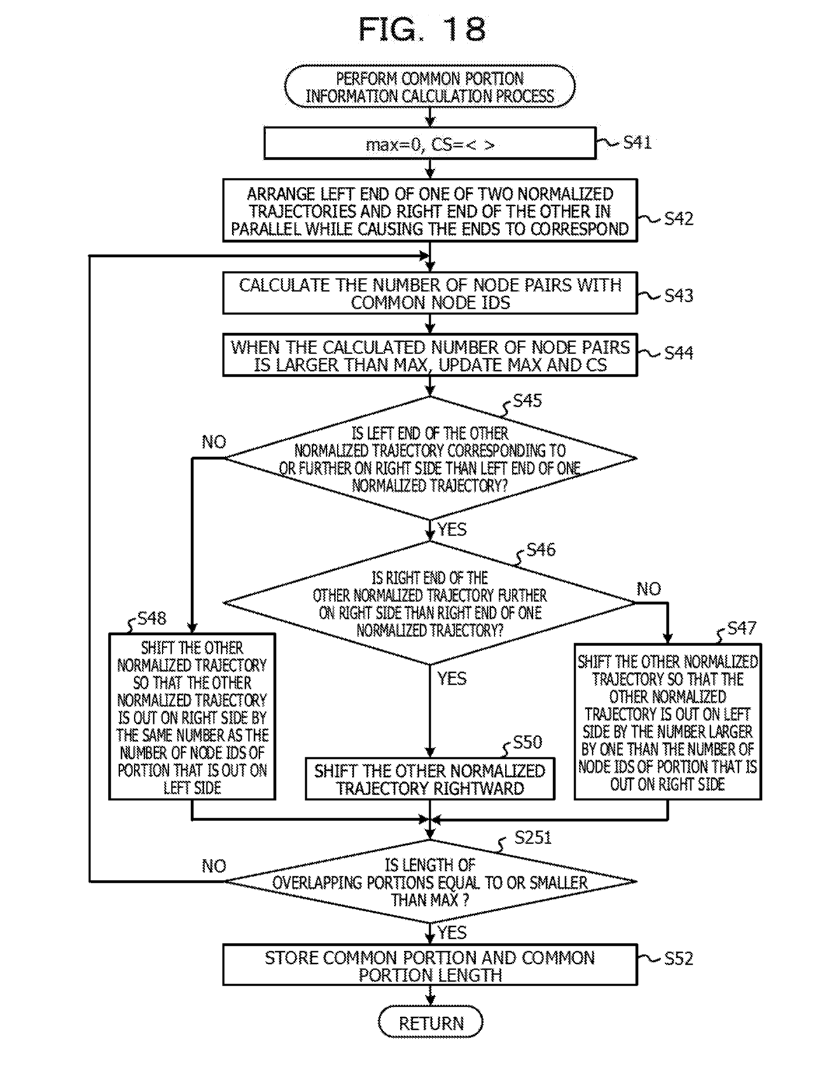

The common information output device 210 according to the second embodiment is described below. Also in the second embodiment, similar to the first embodiment, the common information output process illustrated in FIG. 15 is executed. The common information output process according to the second embodiment is different from the first embodiment in the common portion information calculation process executed in step S40. Hereinafter, referring to FIG. 18, the common portion information calculation process according to the second embodiment is described. The same references are given to a process similar to the common portion information calculation process according to the first embodiment (see FIG. 16) and detailed descriptions thereof are omitted. Also in the second embodiment, similar to the first embodiment, it is assumed that the movement trajectory DB 21 illustrated in FIG. 3 and the road network DB 22 illustrated in FIG. 5 are prepared. It is also assumed that in step S30 of the common information output process illustrated in FIG. 15, normalized trajectories as illustrated in FIG. 7 are obtained.

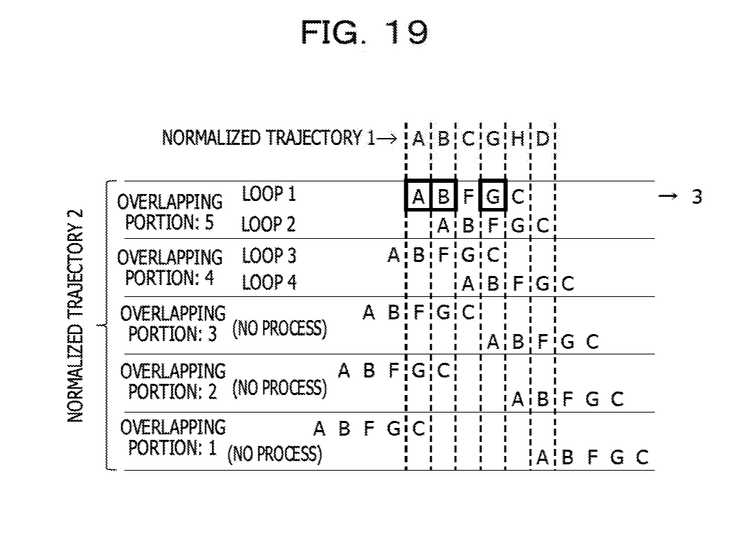

In step S41 of the common portion information calculation process illustrated in FIG. 18, the calculation unit 213 sets max to “0” and sets a sequence CS so that the sequence CS is empty. After that, in step S242, the calculation unit 213 acquires a pair of normalized trajectories from the normalized trajectory DB 23 and arranges the one normalized trajectory included in the pair of normalized trajectories on the upper side and arranges the other normalized trajectory on the lower side in parallel so that the arrangement is the initial arrangement. It is assumed here that the calculation unit 213 arranges the normalized trajectory 1, which is longer, that is, larger in the number of node IDs in the two normalized trajectories, on the upper side and arranges the normalized trajectory 2, which is shorter, that is, smaller in the number of node IDs, on the lower side. Further, as illustrated in the uppermost row and the row of loop 1 in FIG. 19, the calculation unit 213 arranges the normalized trajectory 1 and the normalized trajectory 2 in parallel while causing node ID “A” at the left end of the normalized trajectory 1 and node ID “A” at the left end of the normalized trajectory 2 so that the node IDs are in the same column.

After that, in step S43, the calculation unit 213 calculates the number of node pairs with common node IDs between the normalized trajectory 1 and the normalized trajectory 2. As illustrated in the uppermost row and the row of loop 1 in FIG. 19, three node pairs with common node IDs (see bold dotted-line boxes in FIG. 19) are present. Thus, in step S43, the calculation unit 213 calculates the number of node pairs with common node IDs as “3”. Since this value is larger than current max equal to 0, in subsequent step S44, the calculation unit 213 updates max to 3. Further, the calculation unit 213 updates the sequence CS with the node sequence in which node IDs “A”, “B”, and “G” indicated by each node pair with common node IDs are enumerated so that CS=<A, B, G>.

After that, in step S45, the calculation unit 213 determines whether or not, in the current arrangements of a pair of normalized trajectories, the left end of the other normalized trajectory corresponds to or is further on the right side than the left end of the one normalized trajectory. That is, the calculation unit 213 determines whether or not the other normalized trajectory is out on the left side relative to the other normalized trajectory. When the other normalized trajectory is not out on the left side, the procedure proceeds to step S46 and when the other normalized trajectory is out on the left side, the procedure proceeds to step S48. Since, as illustrated in the uppermost row and the row of loop 1 in FIG. 19, the normalized trajectory 2 is not out on the left side of the normalized trajectory 1 in this case, the procedure proceeds to step S46.

In step S46, the calculation unit 213 determines whether or not, in the current arrangements of a pair of normalized trajectories, the right end of the other normalized trajectory is further on the left side than the right end of the one normalized trajectory. That is, the calculation unit 213 determines whether or not the right end of the other normalized trajectory accords with the right end of the other normalized trajectory, or determines whether or not the other normalized trajectory is out relative to the right side of the one normalized trajectory. When the right end of the other normalized trajectory is further on the left side than the right end of the one normalized trajectory, the procedure proceeds to step S50 and when the right ends of both normalized trajectories accord with each other or the other normalized trajectory is out on the right side, the procedure proceeds to step S47. Since, as illustrated in the uppermost row and the row of loop 1 in FIG. 19, the right end of the normalized trajectory 2 is further on the left side than the right end of the normalized trajectory 1, the procedure proceeds to step S50.

In step S50, as illustrated in the row of loop 2 in FIG. 19, the calculation unit 213 shifts the normalized trajectory 2 arranged on the lower side to the right side by one column.

After that, in step S251, the calculation unit 213 determines whether or not the length of the overlapping portions, that is, the number of node pairs between the normalized trajectories is equal to or smaller than the current value of max. When the length of the overlapping portions is equal to or smaller than max, the procedure proceeds to step S52 and when the length of the overlapping portions is larger than max, the procedure returns to step S43. Since, as illustrated in the uppermost row and the row of loop 2 in FIG. 19, the length of the overlapping portions between the normalized trajectory 1 and the normalized trajectory 2 is “5”, which is larger than the current max equal to 3, the procedure returns to step S43 and the operations of steps S43 to S50 are repeated.

Since in the arrangement indicated in the row of loop 2 in FIG. 19, a node pair with common nodes ID is not present between the normalized trajectory 1 and the normalized trajectory 2, max and CS are not updated. After that, since in the arrangement indicated in the row of loop 2 in FIG. 19, the normalized trajectory 2 is not out on the left side of the normalized trajectory 1 while the right end of the normalized trajectory 2 and the right end of the normalized trajectory 1 correspond to each other, the determination result in step S46 is negative and the procedure proceeds to step S47.

In step S47, the calculation unit 213 shifts the other normalized trajectory so that the other normalized trajectory is out on the left side of the one normalized trajectory by the number larger by one than the number of node IDs of the other normalized trajectory that is out on the right side of the one normalized trajectory. Since in the arrangement indicated in the row of loop 2 in FIG. 19, the number of node IDs by which the normalized trajectory 2 is out on the right side of the normalized trajectory 1 is zero, the normalized trajectory 2 is shifted so that the normalized trajectory 2 is out on the left side of the normalized trajectory 1 by one node ID. Accordingly, the normalized trajectory 2 is in the arrangement indicated in the row of loop 3 in FIG. 19. Since the length of the overlapping portions of this arrangement is “4” and larger than the current max equal to 3, the procedure returns to step S43.

Since in the arrangement indicated in the row of loop 3 in FIG. 19, a node pair with common nodes ID is not present between the normalized trajectory 1 and the normalized trajectory 2, max and CS are not updated. Since in the arrangement indicated in the row of loop 3 in FIG. 19, the normalized trajectory 2 is out on the left side of the normalized trajectory 1, the determination result in step S45 is negative and the procedure proceeds to step S48.

In step S48, the calculation unit 213 shifts the other normalized trajectory so that the other normalized trajectory is out on the right side of the one normalized trajectory by the number of node IDs of the other normalized trajectory that is out on the left side of the one normalized trajectory. Since in the arrangement indicated in the row of loop 3 in FIG. 19, the number of node IDs by which the normalized trajectory 2 is out on the left side of the normalized trajectory 1 is one, the normalized trajectory 2 is shifted so that the normalized trajectory 2 is out on the right side of the normalized trajectory 1 by one node ID. Accordingly, the normalized trajectory 2 is in the arrangement indicated in the row of loop 4 in FIG. 19. Since the length of the overlapping portions of the arrangement is “4” and larger than the current max equal to 3, the procedure returns to step S43.

In the arrangement indicated in the row of loop 4 in FIG. 19, since a node pair with common nodes ID is not present between the normalized trajectory 1 and the normalized trajectory 2, max and CS are not updated. Since in the arrangement indicated in the row of loop 4 in FIG. 19, the normalized trajectory 2 is out on the right side of the normalized trajectory 1, the procedure proceeds to step S47 after step S45 and step S46. After that, in step S47, the calculation unit 213 shifts the normalized trajectory 2 to the arrangement indicated in the upper row of “OVERLAPPING PORTION: 3” in FIG. 19. The length of the overlapping portions of the arrangement is “3”, which is equal to the current max. Since the number of node pairs with common node IDs between the normalized trajectories does not exceed the length of the overlapping portions between the normalized trajectories, max is not updated even when the procedure is further repeated. Thus, here, the process of calculating the number of node pairs with common node IDs between the normalized trajectories and the process of updating max and CS end, and the procedure proceeds to step S52.

In step S52, the calculation unit 213 causes information on the common portion length and the common portion to be stored in the output information DB 24. After that, the common portion information calculation process ends and the procedure returns to the common information output process illustrated in FIG. 15.

As described above, in the common information output device according to the second embodiment, two normalized movement trajectories are arranged in parallel and for each of arrangements different in the number of overlapping nodes, the maximum value of the number of node pairs with common node IDs is calculated as a common portion length. At the time, the calculation is performed sequentially from the arrangement large in the number of overlapping nodes and when the number of overlapping nodes becomes equal to or smaller than the maximum value of the number of node pairs with common node IDs, which is already calculated, the procedure ends. Accordingly, the amount of computation desired for identifying a common portion between movement trajectories may be further reduced.

Although the second embodiment describes a case where an arrangement in which the left end of one movement trajectory and the left end of the other movement trajectory are caused to correspond to each other serves as the initial arrangement, the present disclosure is not limited thereto. An arrangement in which the right end of one movement trajectory and the right end of the other movement trajectory are caused to correspond to each other may serve as the initial arrangement. In this case, when the right end of the other normalized trajectory is present further on the left side than the right end of the one normalized trajectory and the left end of the other normalized trajectory is present further on the right side than the left end of the one normalized trajectory, the other movement trajectory is shifted to the right side by one column. When the other normalized trajectory is out on the right side of the one normalized trajectory, the other normalized trajectory is shifted so that the other normalized trajectory is out on the left side of the one normalized trajectory by the number larger by one than the number of nodes that are out. For another example, when the other normalized trajectory is out on the left side of the one normalized trajectory, the other normalized trajectory is shifted so that the other normalized trajectory is out on the right side of the one normalized trajectory by the number larger by one than the number of nodes that are out.

### Third Embodiment

A third embodiment is described below. The third embodiment describes a route graph generation system that includes a common information output device. In the third embodiment, the same references are given to parts similar to those of the common information output device 10 according to the first embodiment and detailed descriptions thereof are omitted.

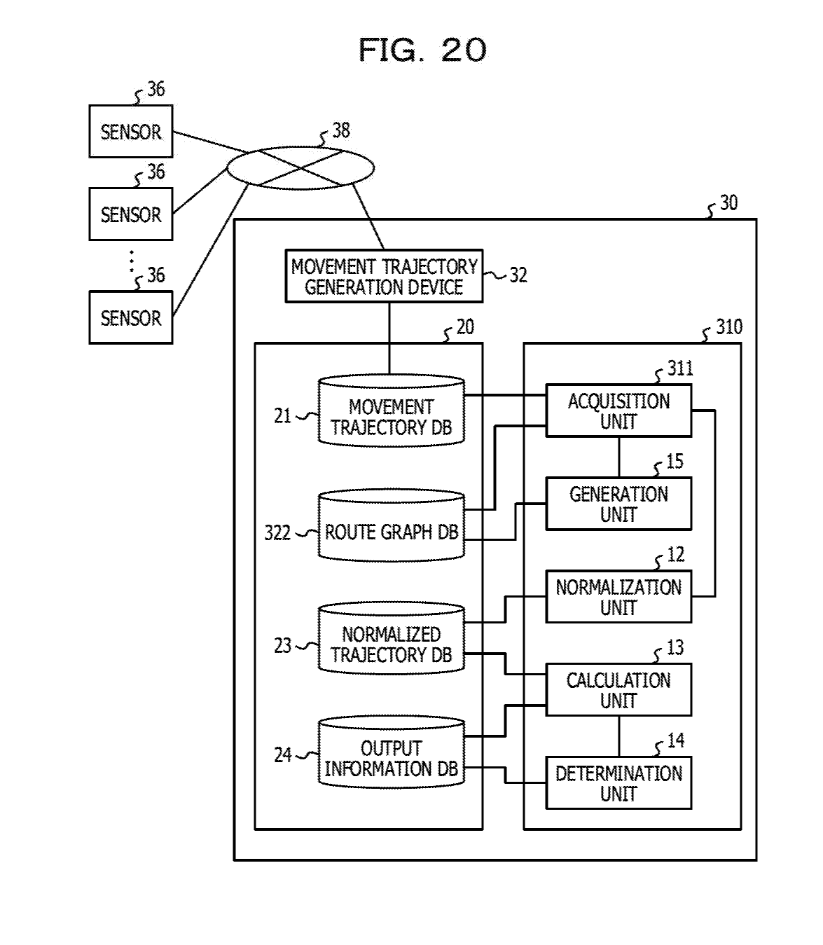

As illustrated in FIG. 20, a route graph generation system 30 according to the third embodiment includes a movement trajectory generation device 32, a storage device 20, and a common information output device 310. The storage device 20 stores a movement trajectory DB 21, a route graph DB 322, a normalized trajectory DB 23, and an output information DB 24.

The movement trajectory generation device 32 acquires observation data, which indicates locations of mobile bodies observed regularly by each of sensors 36 that observe the locations of the mobile bodies, through a network 38. The sensor 36 may be a terminal, such as a mobile phone or a smartphone, held by a human, which is an example of the mobile body, or may be the Global Positioning System (GPS) or the like utilized in a car navigation system or the like mounted on a vehicle, which is an example of the mobile body. The observation data includes location data indicated with the latitude and longitude of each observation point, observation times, and sensor IDs for distinguishing the sensors 36. The movement trajectory generation device 32 extracts a plurality of pieces of acquired observation data for each sensor ID and arranges the location data included in each piece of the observation data on the time series based on the observation times to generate movement trajectory data. The movement trajectory generation device 32 causes the plurality of pieces of generated movement trajectory data to be stored in the movement trajectory DB 21.

In terms of functions, the common information output device 310 includes an acquisition unit 311, a generation unit 15, a normalization unit 12, a calculation unit 13, and a determination unit 14.

The acquisition unit 311 transfers the movement trajectory data acquired from the movement trajectory DB 21 to the generation unit 15. Further, similar to the acquisition unit 11 according to the first embodiment, the acquisition unit 311 transfers the movement trajectory data acquired from the movement trajectory DB 21 and data that indicates the route graph acquired from the route graph DB 322, which is described below, to the normalization unit 12.

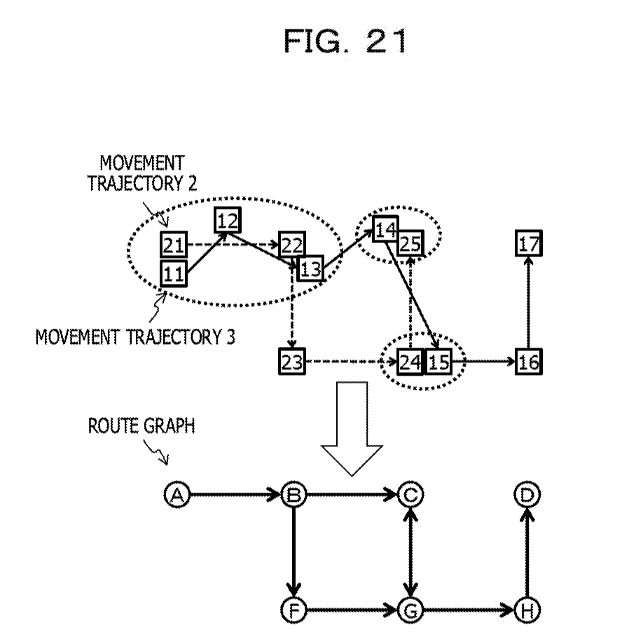

The generation unit 15 generates a route graph from the movement trajectory data transferred from the acquisition unit 311. Similar to the road network according to the first embodiment, the route graph is indicated as a plurality of nodes that are each caused to correspond to the location information and as links that couple the nodes. For example, as illustrated in the upper diagram of FIG. 21, the generation unit 15 generates the route graph indicated in the lower diagram of FIG. 21 by integrating portions with short distances in a plurality of movement trajectories, which are indicated with for example, broken-line ellipse portions in the upper diagram of FIG. 21. Since for example, the method discussed in Japanese Laid-open Patent Publication No. 2015-076069 may be used as the route graph generation method, detailed description thereof is omitted herein. The route graph generation method is not limited to the above-described method.

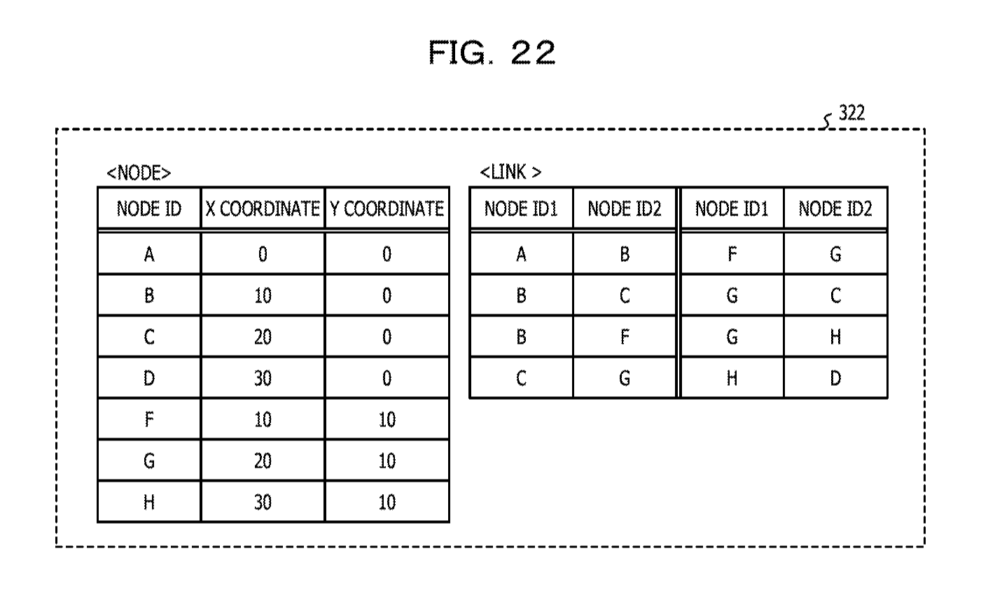

The generation unit 15 causes data that indicates the generated route graph to be stored in the storage device 20 as for example, the route graph DB 322 illustrated in FIG. 22. The data format of the route graph DB 322 is similar to that of the road network DB 22 according to the first embodiment.

The common information output device 310 included in the route graph generation system 30 may be implemented by for example, the computer 40 illustrated in FIG. 14. A common information output program 350 for causing the computer 40 to function as the common information output device 310 is stored in the storage unit 43 of the computer 40.

The CPU 41 reads the common information output program 350 from the storage unit 43 and expands the common information output program 350 in the memory 42 to sequentially execute the processes included in the common information output program 350. The common information output program 350 includes an acquisition process 351, a normalization process 52, a calculation process 53, a determination process 54, and a generation process 55.

The CPU 41 operates as the acquisition unit 311 illustrated in FIG. 20 by executing the acquisition process 351. The CPU 41 further operates as the generation unit 15 illustrated in FIG. 20 by executing the generation process 55. The other processes are similar to those of the common information output program 50 according to the first embodiment. Accordingly, the computer 40 that executes the common information output program 350 functions as the common information output device 310.

The functions implemented by the common information output program 350 may also be implemented by for example, a semiconductor integrated circuit, and more specifically, by an ASIC or the like.

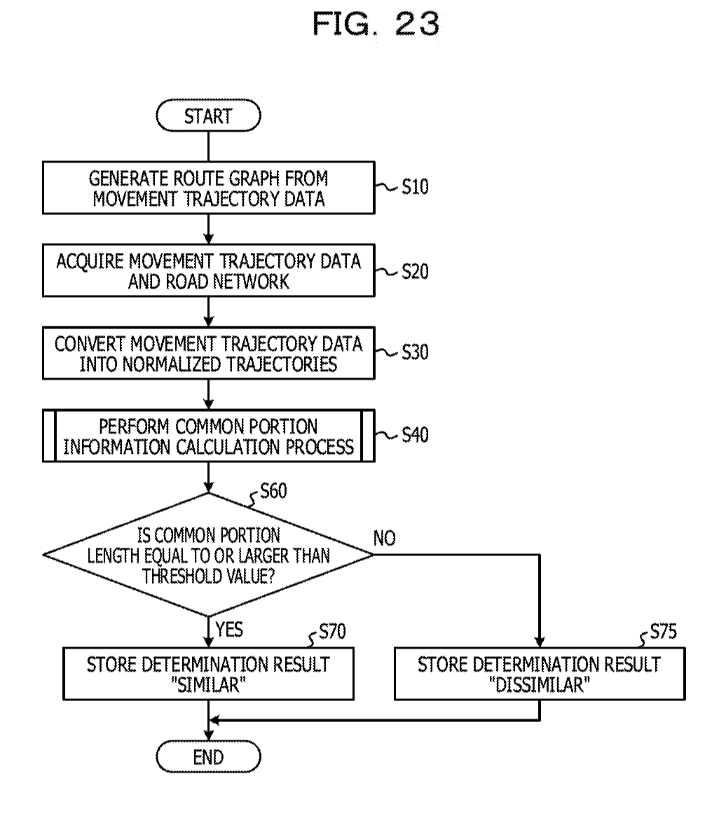

Advantages of the route graph generation system 30 according to the third embodiment are described below. The movement trajectory generation device 32 acquires observation data observed by each of the plurality of sensors 36 through the network 38 and generates movement trajectory data from the observation data to cause the movement trajectory data to be stored in the movement trajectory DB 21. After that, the common information output device 310 executes the route graph generation process illustrated in FIG. 23. The same references are given to operations of the route graph generation process similar to those of the common information output process according to the first embodiment, and detailed descriptions thereof are omitted.

In step S10 of the route graph generation process illustrated in FIG. 23, the acquisition unit 311 acquires movement trajectory data from the movement trajectory DB 21 and transfers the acquired movement trajectory data to the generation unit 15. The generation unit 15 generates a route graph by for example, integrating the movement trajectory data transferred from the acquisition unit 311 and causes the generated route graph to be stored in the route graph DB 322.

Since the process described below is different from the common information output process according to the first embodiment merely in that the route graph generated in step S10 described above is used instead of the road network, the descriptions thereof are omitted.

As described above, according to the third embodiment, a route graph is generated using movement trajectories and information on a common portion between movement trajectories normalized by causing the movement trajectories used for the generation of the route graph to correspond to the route graph is output. Accordingly, along with the route graph, information on the common portion between the movement trajectories used for the generation of the route graph may also be obtained. Since, similar to the first embodiment, the common portion is approximately calculated by utilizing the characteristics of the movement trajectories, the amount of computation desired for identifying the common portion between the movement trajectories may be reduced.

Although the third embodiment describes a case where the common portion information calculation process according to the first embodiment is applied, the common portion information calculation process according to the second embodiment may be applied.

Although the first to third embodiments each describe a case where, as the information on commonness, information on an identified common portion, a common portion length, and a determination result regarding similarity or dissimilarity between movement trajectories are output, the present disclosure is not limited to the case where all of these are output. Any one or two thereof may be output. As another possibility, information on commonness other than these may be output.

Various services may be provided by utilizing information on commonness between movement trajectories, which may be obtained in each of the first to third embodiments. For example, users corresponding to movement trajectories determined to be similar to each other may be provided with information indicating that the users may know each other or information suggesting making friends with each other. As another possibility, for example, users corresponding movement trajectories with a large common portion length may be provided with information suggesting sharing a taxi.

The above-described embodiments each describe an aspect where the common information output programs 50, 250, and 350 are each stored (installed) in the storage unit 43 in advance, the present disclosure is not limited thereto. The common information output program according to the present application may be provided in the form of being recorded in a recording medium, such as compact disc read-only memory (CD-ROM), digital versatile disc read-only memory (DVD-ROM), or Universal Serial Bus (USB) memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A common information output method executed by a computer, the common information output method comprising:
acquiring first trajectory information and second trajectory information, the first trajectory information indicating a first node sequence corresponding to nodes at which a first object has arrived in order, the second trajectory information indicating a second node sequence corresponding to nodes at which a second object has arrived in order;
specifying a number of common node based on the first trajectory information and the second trajectory information when at least a part of the first node sequence indicated by the first trajectory information and at least a part of the second node sequence indicated by the second trajectory information are overlapped, the common node being same node appearing at same position in the overlapped part of the first node sequence and the overlapped part of the second node sequence, the specifying being executed for each of a plurality of patterns of overlap of the first node sequence and the second node sequence; and
outputting information in accordance with the specified number of common node.

2. The common information output method according to claim 1, wherein
the specifying for each of the plurality of patterns of overlap is executed in order with large overlapped part among from the plurality of patterns of overlap.

3. The common information output method according to claim 1, wherein
the outputting includes outputting information that indicates the common node included in a pattern of overlap whose number of common node is maximum among from the plurality of patterns of overlap.

4. The common information output method according to claim 1, wherein
the outputting includes outputting information that indicates a maximum number of common node among from the plurality of patterns of overlap.

5. The common information output method according to claim 1, further comprising:
determining a similarity between the first trajectory information and the second trajectory information based on a maximum number of common node among from the plurality of patterns of overlap and based on a predetermined threshold related to the number of common node.

6. The common information output method according to claim 1, further comprising:
generating a route graph including a plurality of links linking the nodes by integrating a plurality of movement trajectory information indicating transition of geographical position; and
converting the plurality of movement trajectory information to the first trajectory information or the second trajectory information by associating each of the plurality of movement trajectory information with the route graph.

7. A common information output device comprising:
a memory and;
a processor coupled to the memory and configured to:
acquire first trajectory information and second trajectory information, the first trajectory information indicating a first node sequence corresponding to nodes at which a first object has arrived in order, the second trajectory information indicating a second node sequence corresponding to nodes at which a second object has arrived in order;
specify a number of common node based on the first trajectory information and the second trajectory information when at least a part of the first node sequence indicated by the first trajectory information and at least a part of the second node sequence indicated by the second trajectory information are overlapped, the common node being same node appearing at same position in the overlapped part of the first node sequence and the overlapped part of the second node sequence, the specifying being executed for each of a plurality of patterns of overlap of the first node sequence and the second node sequence; and
output information in accordance with the specified number of common node.

8. A non-transitory computer-readable storage medium storing a common information output program that causes a computer to execute a process comprising:
acquiring first trajectory information and second trajectory information, the first trajectory information indicating a first node sequence corresponding to nodes at which a first object has arrived in order, the second trajectory information indicating a second node sequence corresponding to nodes at which a second object has arrived in order;
specifying a number of common node based on the first trajectory information and the second trajectory information when at least a part of the first node sequence indicated by the first trajectory information and at least a part of the second node sequence indicated by the second trajectory information are overlapped, the common node being same node appearing at same position in the overlapped part of the first node sequence and the overlapped part of the second node sequence, the specifying being executed for each of a plurality of patterns of overlap of the first node sequence and the second node sequence; and
outputting information in accordance with the specified number of common node.
